(19) United States
(12) Patent Application Publication
(10) Pub. No.: US 2011/0151282 A1
(43) Pub. Date: Jun. 23, 2011

(54) METHOD FOR MANUFACTURING GLASS SUBSTRATE FOR DATA STORAGE MEDIUM AND GLASS SUBSTRATE

(75) Inventor: Tatsuo NAGASHIMA, Tokyo (JP)

(73) Assignee: Asahi Glass Company, Limited, Chiyoda-ku (JP)

(21) Appl. No.: 12/967,593

(22) Filed: Dec. 14, 2010

(30) Foreign Application Priority Data
Dec. 22, 2009 (JP) 2009-290872

(51) Int. Cl. G11B 5/73; C03C 21/00

(52) U.S. Cl. 428/846.9; 65/30.14; 428/800

(57) ABSTRACT

The present invention relates to a method for manufacturing a glass substrate for data storage mediums, the method including a chemical strengthening treatment step of dipping a glass for a substrate in a mixed molten salt to form a compressive layer on front and back surfaces of the glass for a substrate, in which the glass for a substrate contains a lithium ion as an alkali component, the mixed molten salt contains sodium nitrate, potassium nitrate and lithium nitrate, an amount of lithium nitrate being from 1 to 6% by mass, and the glass for a substrate is dipped in the mixed molten salt at a treatment temperature of 325° C. or more and 475° C. or less for a treatment time of 30 minutes or less, under the requirement satisfying the following formula: 1900≦T×log(t²)≦2900, in which T is a treatment temperature (unit: K) and t is a treatment time (unit: second).

### FIELD OF THE INVENTION

The present invention relates to a method for manufacturing a glass substrate to be used for data storage mediums such as magnetic disk and optical disk, and a glass substrate.

### BACKGROUND OF THE INVENTION

As the glass for a substrate of data storage mediums such as magnetic disk and optical disk (hereinafter sometimes referred to as “the glass for a substrate”), for example, lithium-containing aluminosilicate-based glass having a high Young's modulus or glass obtained by subjecting it to a chemical strengthening treatment (see, for example, Patent Document 1) is used.

In recent years, with an increase in the storage capacity of a hard disk drive, the trend for high recording density proceeds at high pace, and requirements for disk flutter characteristics or impact characteristics during operation are becoming severer. Furthermore, along with smaller diameter of a hard disk drive, the requirement for impact characteristics at the non-operation time is also strong. In order to meet these requirements, a chemical strengthening treatment is applied to the main surface or the like of the glass for a substrate to form a compressive stress layer thereon with an attempt to enhance the strength (see, for example, Patent Document 2).

However, as the recording density increases, not only the demand for strength but also the demands for accuracy of the surface condition (e.g., scratch, attachment) on the main surface of a glass and for accuracy of the disk shape such as flatness, waviness and roughness grow stringent each year, and the change in the surface condition or disk shape due to a chemical strengthening treatment applied becomes a problem.

Therefore, for example, as in Patent Document 3, lap polishing or precise polishing is performed after chemical strengthening, and at the final cleaning, removal of deposits attributable to contaminations contained in a chemical strengthening salt or a strengthening salt is devised.
Patent Document 1: JP-A 2001-180969
Patent Document 2: JP-A 10-198942
Patent Document 3: JP-A 2006-324006

### SUMMARY OF THE INVENTION

The chemical strengthening treatment is by itself a process imposing a load in the production process of a glass substrate for data storage mediums. When polishing or a special cleaning process is applied after the chemical strengthening treatment, this imposes a larger load and may put pressure on the manufacturing process.

Accordingly, the present invention has an object to provide a method for manufacturing a glass substrate for data storage mediums, which stabilizes a disk shape without applying a specific treatment after a chemical strengthening treatment, and a glass substrate for data storage mediums.

As a result of various investigations to achieve the above object, the present inventors have found that chemical strengthening treatment time has high sensitivity to shape change, particularly waviness.

They have further found a method for manufacturing a glass substrate for data storage mediums, in which disk shape is stabilized, particularly generation of waviness is small and chemical strengthening is sufficient, without being subjected to a specific treatment after the chemical strengthening treatment by conducting the chemical strengthening treatment under specific conditions, and preferably by well combining a composition of a glass for a substrate and a composition of a mixed molten salt used in the chemical strengthening treatment. This makes it possible to sufficiently perform strengthening while inhibiting shape change.

That is, they have found that when a glass for a substrate, containing a lithium ion as an alkali component is dipped in a mixed molten salt containing an appropriate amount of lithium nitrate under the conditions of specific temperature range and time, thereby performing the chemical strengthening treatment, change of glass shape after the chemical strengthening treatment is inhibited and strengthening is sufficient. A technique for adding lithium nitrate to the mixed molten salt is disclosed in JP-A 2004-259402. However, in a range of a slight amount of lithium nitrate, strengthening stability is maintained, but the effect of inhibiting shape change has not been found.

Accordingly, the present invention relates to the following items.

1. A method for manufacturing a glass substrate for data storage mediums, the method comprising a chemical strengthening treatment step of dipping a glass for a substrate in a mixed molten salt to form a compressive layer on front and back surfaces of the glass for a substrate,

wherein the glass for a substrate contains a lithium ion as an alkali component,

the mixed molten salt contains sodium nitrate, potassium nitrate and lithium nitrate, an amount of lithium nitrate being from 1 to 6% by mass, and

the glass for a substrate is dipped in the mixed molten salt at a treatment temperature of 325° C. or more and 475° C. or less for a treatment time of 30 minutes or less, under the requirement satisfying the following formula:

1900≦T×log(t²)≦2900

in which T is a treatment temperature (unit: K) and t is a treatment time (unit: second).

2. The method for manufacturing a glass substrate for data storage mediums according to item 1, wherein the glass for a substrate subjected to said chemical strengthening treatment has a fracture toughness value K_{c} measured by an IF method according to JIS R1607, of 1.2 MPa·m^{1/2} or more.

3. The method for manufacturing a glass substrate for data storage mediums according to item 1 or 2, wherein the mixed molten salt comprises, in terms of mass percent, from 28 to 55% of sodium nitrate and from 40 to 69% of potassium nitrate, and has a melting point of 250° C. or lower.

4. The method for manufacturing a glass substrate for data storage mediums according to any one of items 1 to 3, wherein, in the chemical strengthening treatment step, the step of dipping the glass for a substrate in the mixed molten salt is limited to one step.

5. The method for manufacturing a glass substrate for data storage mediums according to any one of items 1 to 4, wherein, in the chemical strengthening treatment step, the glass for a substrate to be dipped in the mixed molten salt has a temperature not lower than the melting point of the mixed molten salt.

6. The method for manufacturing a glass substrate for data storage mediums according to any one of items 1 to 5, wherein, in the chemical strengthening treatment step, after dipping the glass for a substrate in the mixed molten salt, the glass for a substrate is not annealed, and after reaching a temperature of the glass for a substrate to 300° C. or lower, the glass for a substrate is quenched by bringing into contact with a cooling medium at a cooling rate of 100° C./minute or more.

7. The method for manufacturing a glass substrate for data storage mediums according to any one of items 1 to 6, wherein, after the chemical strengthening treatment step, the glass for a substrate is not repolished.

8. The method for manufacturing a glass substrate for data storage mediums according to any one of items 1 to 7, wherein the glass for a substrate comprises, in terms of mol % on the basis of oxides, from 58 to 66% of SiO₂, from 11 to 17% of Al₂O₃, from 0 to 4% of MgO, from 8 to 16% of Li₂O, and from 2 to 9% of Na₂O, provided that Li₂O+Na₂O is from 13 to 21%.

9. The method for manufacturing a glass substrate for data storage mediums according to any one of items 1 to 8, wherein the glass for a substrate has a value obtained by dividing a content of Li₂O in terms of mol % on the basis of oxides by a total content (R₂O) of Li₂O, Na₂O and K₂O of 0.4 or more.

10. The method for manufacturing a glass substrate for data storage mediums according to any one of items 1 to 9, wherein a glass disk for storage medium molded from the glass for a substrate having been subjected to the chemical strengthening treatment has:

a flatness of 3 μm or less;

an arithmetic average waviness (Wa) with cut-off values of 0.4 mm and 5 mm on a surface between a radius of 16 mm and a radius of 28 mm from a center of a 2.5-inch disk of said glass disk, of 0.6 nm or less; and

an arithmetic average roughness (Ra) of 0.15 nm or less.

11. A glass substrate for data storage mediums, produced by the manufacturing method according to any one of items 1 to 10.

12. A data storage medium comprising the glass substrate for data storage mediums according to item 11, and a magnetic recording layer formed on said glass substrate.

13. A method for manufacturing a glass substrate for data storage mediums, the method comprising a chemical strengthening treatment step of dipping a glass for a substrate in a mixed molten salt to form a compressive layer on front and back surfaces of the glass for a substrate,

wherein the glass for a substrate contains a lithium ion as an alkali component,

the mixed molten salt contains sodium nitrate, potassium nitrate and lithium nitrate, an amount of lithium nitrate being from 1 to 6% in terms of mass percent, and

the glass for a substrate is dipped in the mixed molten salt at a temperature of 325° C. or more and lower than 425° C. for from 5 to 30 minutes.

14. A method for manufacturing a glass substrate for data storage mediums, the method comprising a chemical strengthening treatment step of dipping a glass for a substrate in a mixed molten salt to form a compressive layer on front and back surfaces of the glass for a substrate,

wherein the glass for a substrate contains a lithium ion as an alkali component,

the mixed molten salt contains sodium nitrate, potassium nitrate and lithium nitrate, an amount of lithium nitrate being from 1 to 6% in terms of mass percent, and the glass for a substrate is dipped in the mixed molten salt at a temperature of 425° C. or more and 475° C. or less for from 3 to 20 minutes. Incidentally, the dipping time is typically from 5 to 20 minutes.

The manufacturing method of the present invention makes it possible to obtain a glass substrate for data storage mediums, in which impact resistance is excellent, disk shape can be stabilized, and particularly generation of waviness is small, without being subjected to a specific treatment after the chemical strengthening treatment.

### DETAILED DESCRIPTION OF THE INVENTION

In the method for manufacturing a glass substrate for data storage mediums of the present invention, the conditions except for the composition of the glass for a substrate used and the chemical strengthening treatment process are not particularly limited and may be appropriately selected, and typically, conventionally known processes can be applied.

For example, raw materials of respective components are blended to obtain the later-described composition, and the blend is melted in a glass melting furnace. The glass is homogenized by bubbling, stirring, addition of a refining agent, or the like, molded into a glass plate having a predetermined thickness by a conventionally known molding method to obtain glass for a substrate, and then annealed.

Examples of the molding method of glass include a float process, a pressing process, a fusion process and a downdraw process. In particular, a float process suited for mass production is preferred. The continuous molding methods other than the float process, that is, a fusion process and a downdraw process, are also preferred.

The molded glass for a substrate is, if desired, subjected to a grinding/polishing treatment and a chemical strengthening treatment, then cleaned and dried to obtain a glass substrate for data storage mediums, having a predetermined shape/size.

The chemical strengthening treatment is a treatment of dipping the glass for a substrate in a mixed molten salt, thereby forming a compressive layer on the front and back surfaces of the glass for a substrate. In the manufacturing method of the present invention, the chemical strengthening treatment may be performed after the grinding/polishing treatment, or while the chemical strengthening treatment is first performed, the grinding/polishing treatment may be then performed. It is also possible to perform the chemical strengthening treatment when the grinding/polishing treatment has proceeded to a certain stage, and then perform the remaining process of the grinding/polishing treatment.

The cleaning and drying process is not particularly limited and, for example, the glass is cleaned in sequence with a neutral detergent and pure water by applying an ultrasonic wave in a multi-bath cleaning tank and dried by spin drying. Also, warm water may be used instead of a neutral detergent, or the glass after washing with pure water may be passed through an IPA (isopropyl alcohol) cleaning bath and after IPA vapor drying, pulled up to obtain the glass substrate.

The thus-obtained glass substrate for data storage mediums of the present invention is preferably a circular glass plate having a thickness of typically from 0.5 to 1.5 mm and a diameter of 48 to 93 mm. Also, in the case of a glass substrate for magnetic disks and the like, it is usually preferred to core a hole having a diameter of 15 to 25 mm in the center of the glass substrate.

### [Glass for Substrate]

### (Composition)

The glass for a substrate used in the manufacturing method of the present invention is a glass containing a lithium ion as an alkali component. The preferred composition (described in the item 8 above) of the glass for a substrate used in the manufacturing method of the present invention is described below. Unless otherwise indicated, the content of each component is shown in terms of mol percent.

### (1) SiO₂

SiO₂ is a component for forming a network of a glass for a substrate and is essential. The content of SiO₂ in the glass for a substrate is preferably 58% or more, and more preferably 61% or more. Furthermore, the content of SiO₂ is preferably 66% or less.

When the content of SiO₂ in the glass for a substrate is less than 58%, acid resistance or weather resistance is lowered, a density (d) becomes large, and the glass is liable to be scratched. Alternatively, a liquidus temperature (T_{L}) rises so that the glass becomes unstable. On the other hand, when the content of SiO₂ exceeds 66%, a melting temperature and a temperature (T₄) at which a viscosity becomes 10⁴ dPa·s rise so that melting and molding of the glass become difficult; a Young's modulus (E) or a specific modulus (E/d) become low; or an average coefficient of linear expansion (α) at from −50 to 70° C. of the glass becomes small.

When acid resistance of the glass for a substrate is desired to further increase, the content of SiO₂ in the glass for a substrate is preferably 62% or more, more preferably 62.5% or more, and especially preferably 63.5% or more.

### (2) Al₂O₃

Al₂O₃ has an effect of increasing Tg, weather resistance and a Young's modulus, enhancing the ion exchangeability in chemical strengthening and is essential. The content of Al₂O₃ in the glass is preferably 11% or more, and more preferably 12% or more. On the other hand, the content of Al₂O₃ is preferably 17% or less, and more preferably 15% or less.

When the content of Al₂O₃ in the glass for a substrate is less than 11%, the above-described effect becomes small, and there is a concern that even when chemical strengthening is applied, sufficiently high impact resistance may not be obtained. When the content of Al₂O₃ exceeds 17%, a melting temperature and T₄ rise so that melting and molding of the glass for a substrate become difficult. As a result, there is a concern that a becomes small or T_{L} becomes too high.

When acid resistance is desired to further increase, the content of Al₂O₃ in the glass for a substrate is preferably 15% or less, and more preferably 14% or less. When acid resistance is desired to particularly increase, the content of SiO₂ in the glass for a substrate is preferably 63.5% or more, and the content of Al₂O₃ in the glass for a substrate is preferably 14% or less.

### (3) Li₂O

Li₂O has an effect of increasing E, E/d or α and additionally improving melting character of the glass for a substrate. Main exchange ion of chemical strengthening in the present invention is the exchange of from Li⁺ to Na⁺. Therefore, Li₂O is essential. The content of Li₂O in the glass for a substrate is preferably 8% or more, more preferably 9% or more, and especially preferably 10% or more. On the other hand, the content of Li₂O is preferably 16% or less, more preferably 15% or less, and especially preferably 14% or less.

When the content of Li₂O in the glass for a substrate is less than 8%, the above-described effect is small. On the other hand, when the content of Li₂O exceeds 16%, acid resistance or weather resistance is lowered, or Tg is lowered.

### (4) Na₂O

Na₂O has an effect of increasing α and additionally improving melting character of the glass for a substrate, and is therefore essential. The content of Na₂O in the glass for a substrate is preferably 2% or more, and more preferably 3% or more. On the other hand, the content of Na₂O is preferably 9% or less, more preferably 7.5% or less, and especially preferably 7% or less.

When the content of Na₂O in the glass for a substrate is less than 2%, the above-described effect is small. On the other hand, when the content of Na₂O exceeds 9%, strengthening may be difficult to achieve when performing the chemical strengthening treatment, the acid resistance or weather resistance may be reduced, or Tg may become low.

### (5) Li₂O+Na₂O

The total content of Li₂O+Na₂O in the glass for a substrate is preferably 13% or more, and more preferably 14% or more. On the other hand, the total content of Li₂O+Na₂O is preferably 21% or less, and more preferably 20% or less.

When the total content of Li₂O+Na₂O in the glass for a substrate is less than 13%, strengthening is difficult to achieve when performing the chemical strengthening treatment, a becomes small, or the melting character of the glass is lowered. On the other hand, the total content of Li₂O+Na₂O exceeds 21%, the Tg may become too low, stress relaxation may occur to leave no strengthening even when the chemical strengthening treatment is performed, or the acid resistance or weather resistance may be lowered.

### (6) K₂O

K₂O has an effect of increasing α or improving melting character of the glass for a substrate. The content of K₂O in the glass for a substrate is preferably 2.5% or more, and more preferably 3% or more. On the other hand, the content of K₂O is preferably 8% or less, more preferably 6% or less, and especially preferably 5% or less.

When the content of K₂O in the glass for a substrate is less than 2.5%, thereby attempting to increase Na₂O and to maintain α, weather resistance is lowered. On the other hand, the content of K₂O exceeds 8%, strengthening may be difficult to achieve when performing the chemical strengthening treatment, the acid resistance or weather resistance may be lowered, or E or E/d may decrease.

When the glass for a substrate contains K₂O, the value obtained by dividing the content of Li₂O in the glass for a substrate by the total content (R₂O) of Li₂O, Na₂O and K₂O is preferably 0.4 or more, and more preferably 0.5 or more.

When the value obtained by dividing the content of Li₂O in the glass for a substrate by the total content (R₂O) of Li₂O, Na₂O and K₂O is less than 0.4, strengthening may be difficult to achieve when performing the chemical strengthening treatment, or due to dipping in the molten salt, the strength may become lower than the bulk glass.

### (7) MgO

MgO is not essential but has an effect of raising E, E/d or a while maintaining the weather resistance, making it difficult to scratch the glass for a substrate, and at the same time, enhancing the melting character of the glass for a substrate. The content of MgO in the glass for a substrate is preferably 4% or less, more preferably 3% or less.

On the other hand, the content of MgO is typically 1% or more. When the content of MgO in the glass for a substrate exceeds 4%, strengthening is difficult to achieve when performing the chemical strengthening treatment, or T_{L} becomes too high.

### (8) TiO₂

TiO₂ is not essential but has an effect of raising E, E/d or Tg or enhancing the weather resistance. The content of TiO₂ in the glass for a substrate is preferably 4% or less, more preferably 3% or less, still more preferably 2% or less, and is preferably 0.3% or more, more preferably 0.6% or mores, still more preferably 0.8% or more. When the content of TiO₂ in the glass for a substrate exceeds 4%, T_{L} may become too high or a phase separation phenomenon may be likely to occur.

The total of the Al₂O₃, MgO and TiO₂ contents in the glass for a substrate is preferably 12% or more. When this total is less than 12%, it may become difficult to raise E or E/d while maintaining the weather resistance.

### (9) ZrO₂

ZrO₂ is not essential but has an effect of, for example, enhancing the ion exchange rate when the chemical strengthening treatment is performed, increasing E or E/d while maintaining the weather resistance, raising Tg, or enhancing the melting character of the glass for a substrate. The content of ZrO₂ in the glass for a substrate is preferably 3% or less, more preferably 2% or less. When the content exceeds 3%, d may become large to make the glass brittle and at the same time, T_{L} may become too high.

Although the preferred glass for a substrate used in the manufacturing method of the present invention is essentially composed of the above components, it may further contain other components so far as the object of the present invention is not impaired. In this case, the total content of the other components is preferably 5% or less, and typically 2% or less.

For example, CaO, SrO and BaO may be contained in the glass for a substrate in the total content up to 5% in order to increase a while maintaining weather resistance of the glass for a substrate and additionally improving melting character of the glass for a substrate. When the content of CaO, SrO or BaO exceeds 5%, strengthening is difficult to achieve when performing the chemical strengthening treatment, d becomes large, or the glass for a substrate is liable to be scratched. The total content is preferably 2% or less, and typically 1% or less.

The glass for a substrate may contain a refining agent such as SO₃, Cl, As₂O₃, Sb₂O₃ and SnO₂ in an amount of up to 2% in total, and may contain a colorant such as Fe₂O₃, CO₃O₄ and NiO in an amount of up to 2% in total.

Incidentally, B₂O₃ is very likely to volatilize when present together with an alkali metal oxide component and therefore, is preferably not contained in the glass for a substrate, and even if contained, its content is preferably less than 1%, more preferably less than 0.5%.

### (Glass Transition Temperature)

The glass transition temperature (Tg) of the glass for a substrate is preferably 510° C. or more. If it is less than 510° C., the glass temperature may become low for the optimal temperature of the chemical strengthening molten salt and stress relaxation may occur, failing in obtaining sufficient strengthening. The glass transition temperature is more preferably 525° C. or more.

### (Average Coefficient of Linear Expansion)

The average coefficient of linear expansion (a) at −50 to 70° C. of the glass for a substrate is preferably 60×10⁻⁷/° C. or more, more preferably 65×10⁻⁷/° C. or more, still more preferably 70×10⁻⁷/° C. or more, and most preferably 73×10⁻⁷/° C. or more. Typically, the average coefficient of linear expansion is preferably 90×10⁻⁷/° C. or less. If it is less than 60×10⁻⁷/° C., this may be lower than a of the conventionally employed glass for a substrate and since a of the metal for the hub fixed to the substrate is typically 100×10⁻⁷/° C. or more, the difference in a between the hub and the glass for a substrate becomes large, as a result, the glass for a substrate may be easily broken.

### (Viscosity)

In the glass for a substrate, the difference ΔT (=T₄−T_{L}) between the temperature (T₄) at which the viscosity becomes 10⁴ dPa·s and the liquidus temperature (T_{L}) is preferably −70° C. or more, more preferably 0° C. or more, still more preferably 10° C. or more, and most preferably 20° C. or more. If this difference is less than −70° C., it may be difficult to mold the glass for a substrate into a glass plate, and if the difference is less than 0° C., float molding may become difficult.

### (Density)

The density of the glass for a substrate is preferably 2.6 g/cm³ or less, more preferably 2.5 g/cm³ or less. If the density exceeds 2.6 g/cm³, weight reduction of the data recording medium may be hardly realized, the power consumption required for driving the recording medium may increase, the disk may be readily vibrated by the effect of a windage loss during its rotation, leading to an error in reading, or when the recording medium receives a shock, the substrate is likely to be deflected to produce a stress and may be easily broken.

### (Young's Modulus)

The Young's modulus of the glass for a substrate is preferably from 75 to 90 GPa, more preferably 78 GPa or more, and most preferably 80 GPa or more, and is typically 87 GPa or less. If the Young's modulus is less than 75 GPa, the disk may be readily vibrated by the effect of a windage loss during its rotation, leading to an error in reading, or when a recording medium receives a shock, the substrate is likely to be deflected to produce a stress and may be easily broken, whereas if it exceeds 90 GPa, the polishing rate may be reduced, or a local stress may be readily produced to cause breakage.

### [Chemical Strengthening Treatment Step]

### (Mixed Molten Salt)

The composition of the mixed molten salt used in the chemical strengthening treatment step in the manufacturing method of the present invention is described below. Unless otherwise indicated, the content of each component is shown in terms of mass percent.

### (1) Lithium Nitrate

Lithium nitrate has an effect of, at the ion exchange of Li⁺ in the molten salt, making uniform the in-plane distribution in the strengthening compressive layer of the glass surface layer and acting to suppress the change in shape of the glass after the chemical strengthening treatment and therefore, is essential. The content of lithium nitrate in the mixed molten salt is 1% or more, and preferably 2% or more. The content of lithium nitrate is 6% or less, and more preferably 4% or less.

When the content of lithium nitrate in the mixed molten salt is less than 1%, the above-described effect becomes small. On the other hand, when the content of lithium nitrate exceeds 6%, exchange of Na and K in the glass for a substrate with Li is accelerated, and there is a concern that the glass is difficult to be strengthened. Also, the surface layer of the glass for a substrate becomes a tensile layer but not a compressive layer, and the strength may become lower than that of the bulk glass.

### (2) Sodium Nitrate

In the manufacturing method of a glass substrate of the present invention, sodium nitrate is essential, because main strengthening is brought about by the ion exchange of Na⁺ in the mixed molten salt with Li in the glass. The content of sodium nitrate in the mixed molten salt is preferably 28% or more, and more preferably 30% or more. Furthermore, the content of sodium nitrate is preferably 60% or less, and more preferably 55% or less.

When the content of sodium nitrate in the mixed molten salt is less than 28%, chemical strengthening may become difficult to achieve and at the same time, the melting point of the mixed molten salt may rise, making it difficult to handle the mixed molten metal. On the other hand, when the content of the sodium nitrate exceeds 55%, the melting point of the mixed molten salt may rise and handling of the molten salt may become difficult. Also, the shape of the glass may be greatly changed after the chemical strengthening treatment.

### (3) Potassium Nitrate

In the manufacturing method of a glass substrate of the present invention, the rate of ion exchange of K⁺ in the mixed molten salt with Li or Na in the glass is low as compared with the ion exchange of Li and Na and therefore, potassium nitrate is not a main strengthening ion but is essential, because the melting point of the mixed molten salt lowers due to the freezing-point depression and unlike lithium nitrate, it does not occur that when the content is too large, strengthening becomes difficult to achieve. The content of potassium nitrate in the mixed molten salt is preferably 40% or more, and more preferably 43% or more. Furthermore, the content of potassium nitrate is preferably 69% or less, and more preferably 65% or less.

When the content of potassium nitrate in the mixed molten salt is less than 40%, the melting point of the mixed molten salt may rise and handling of the molten salt may become difficult. On the other hand, when the content exceeds 69%, the melting point of the mixed molten salt may rise, making it difficult to handle the molten salt, and at the same time, chemical strengthening may become difficult to achieve.

The mixed molten salt for use in the manufacturing method of the present invention is substantially composed of the above-described components but may contain other components within the range not impairing the object of the present invention. Examples of other components include an alkali sulfate, an alkali chloride salt, an alkaline earth sulfate and an alkaline earth chloride salt, such as sodium sulfate, potassium sulfate, sodium chloride, potassium chloride, calcium sulfate, strontium sulfate, barium sulfate, calcium chloride, strontium chloride and barium sulfate.

The content of these other components in the mixed molten salt is preferably 5% or less, more preferably 1% or less. Within this range, the other components have an effect of preventing volatilization during melting of the molten mixed salt. If the content exceeds 5%, strengthening becomes difficult to achieve when performing the chemical strengthening treatment.

The melting point of the mixed molten salt used in the manufacturing method of the present invention is preferably 250° C. or lower, and more preferably 230° C. or lower. When the melting point of the mixed molten salt is higher than 250° C., when pulling out the glass for a substrate after the chemical strengthening treatment, the solidification of the molten salt deposited may occur to thereby generate stress on the surface of the glass for a substrate, and there is a concern that flatness, arithmetic average waviness (Wa) and arithmetic roughness (Ra) are increased.

### (Conditions of Chemical Strengthening Treatment)

The chemical strengthening treatment is a treatment of dipping the glass for a substrate in a mixed molten salt, thereby forming a compressive layer on the front and back surfaces of the glass for a substrate. In the manufacturing method of the present invention, the treatment conditions at the chemical strengthening treatment are not particularly limited and may be appropriately selected from conventionally known methods.

### (1) Heating Temperature of Mixed Molten Salt and Dipping Time

The heating temperature of the mixed molten salt and the time of dipping the glass for a substrate in the mixed molten salt are 325° C. or more and 475° C. or less, and 30 minutes or less, respectively, and are essential that the value (CSC) represented by the following formula is satisfied with 1,900 or more and 2,900 or less. In the formula, T is a treatment temperature (unit: K), and t is a treatment time (unit: second).

CSC=T×log(t²)

When the heating temperature of the mixed molten salt is lower than 325° C., the ion exchange rate may drop, and there is a concern that strengthening may become difficult to achieve in a short period of time. On the other hand, when the heating temperature exceeds 475° C., there is a concern that flatness, arithmetic average waviness (Wa) and arithmetic average roughness (Ra) of the glass disk for data storage mediums described hereinafter become large by the chemical strengthening treatment.

The upper limit of the heating temperature of the mixed molten salt is preferably lower than (Tg−100)° C. of the glass for use in the manufacturing method of the present invention. When the upper limit is higher than (Tg−100)° C., there is a concern that the glass may not be sufficiently strengthened due to stress relaxation, despite occurrence of ion exchange.

The time of dipping the glass for a substrate in the mixed molten salt is 30 minutes or less. When the dipping time exceeds 30 minutes, there is a concern that flatness, arithmetic average waviness (Wa) and arithmetic average roughness (Ra) of the glass disk for data storage mediums described hereinafter become large by the chemical strengthening treatment in the above-described treatment temperature range. Furthermore, there is a concern that the takt time in the production process may be reduced, and this may put pressure on the cost.

Furthermore, when the CSC value is less than 1,900, the balance between the treatment temperature and the treatment time is poor, and there is a concern the glass may not be sufficiently strengthened. The CSC value is preferably 2,000 or more, and more preferably 2,200 or more. On the other hand, when the CSC value exceeds 2,900, the treatment time to the treatment temperature is too long, and there is a concern that flatness, arithmetic average waviness (Wa) and arithmetic average roughness (Ra) of the glass disk for data storage mediums described hereinafter become large by the chemical strengthening treatment. The CSC value is preferably 2,800 or less.

The heating temperature of the mixed molten salt and the time of contacting the glass for a substrate with the mixed molten salt may be any one of the following (I) and (II).

(I) The glass for a substrate is dipped in the mixed molten salt heated to a temperature of 325° C. or more and lower than 425° C. for from 5 to 30 minutes.

(II) The glass for a substrate is dipped in the mixed molten salt heated to a temperature of 425° C. or more and 475° C. or less for from 3 to 20 minutes.

In the manufacturing method of the present invention, it is preferred that the step of dipping the glass for a substrate in the mixed molten salt is limited to one step in the chemical strengthening treatment step.

### (2) Preheating Temperature of Glass for Substrate

It is preferred that before dipping the glass for a substrate in the mixed molten salt, the glass for a substrate is preheated at a temperature not lower than the melting point of the mixed molten salt. This is performed to prevent solidification of the molten salt on the glass surface during dipping in the mixed molten salt and suppress reduction in the ion exchange rate or uneven distribution of the compressive layer in the glass plane.

The preheating temperature of the glass for a substrate is preferably less than 400° C., more preferably 350° C. or less. This is because when the preheating temperature is 400° C. or more, the shape may change by the effect of residual stress at the preheating or due to non-uniform temperature in the glass plane, for example, at the contact portion thereof with a sample holder.

### (3) Cooling of Glass for a Substrate

It is preferred that after the step of dipping the glass for a substrate in the mixed molten salt, the glass for a substrate does not pass through an annealing step, keeps from 30 seconds to 2 minutes so that the temperature of the glass for a substrate becomes 300° C. or lower, and is then quenched by contacting with a cooling medium. The cooling rate of the glass for a substrate is preferably 100° C./min or more. Furthermore, the cooling rate is preferably 4,000° C./min or less, and more preferably 3,000° C./min or less.

When the cooling rate of the glass for a substrate is less than 100° C./min, the molten salt depositing on the glass for a substrate may allow the ion exchange to proceed only at the portion in contact with the molten salt even in the course of cooling, and the distribution of the strengthening layer in the glass plane may become non-uniform, as a result, the flatness and arithmetic average waviness (Wa) of the later-described glass disk for data storage mediums may be increased.

On the other hand, when the cooling rate of the glass for a substrate exceeds 4,000° C./min, the arithmetic average waviness (Wa) and the arithmetic average roughness (Ra) may be increased. Also, when the glass is quenched by contacting it with a cooling medium without passing through holding, the glass for a substrate may be broken due to heat shock. Furthermore, the arithmetic average waviness (Wa) and arithmetic average roughness (Ra) may be increased.

In the manufacturing method of the present invention, it is preferred that the glass for a substrate is not repolished after the chemical strengthening treatment. The reason for this is that according to the manufacturing method of the present invention, the shape of the glass for a substrate is sufficiently stabilized even though the glass for a substrate is not repolished after the chemical strengthening treatment step.

### (Characteristics of Glass for Substrate Subjected to Chemical Strengthening Treatment and Glass Disk)

Characteristics of glass for a substrate subjected to the chemical strengthening treatment, and glass disk molded from the glass for a substrate are described below.

### (1) Fracture Toughness Value K_{c}

In the glass for a substrate subjected to the chemical strengthening treatment, the fracture toughness value K_{c} measured by the IF method in accordance with JIS R1607 is preferably 1.2 MPa·m^{1/2} or more, more preferably 1.4 MPa·m^{1/2} or more, still more preferably 1.6 MPa·m^{1/2} or more. When K_{c} of the glass for a substrate is less than 1.2 MPa·m^{1/2}, sufficiently high impact resistance may not be obtained.

### (2) K_{c}/K_{bulk}

In the glass for a substrate subjected to the chemical strengthening treatment, the value K_{c}/K_{bulk} obtained by dividing the fracture toughness value above by the fracture toughness value K_{bulk} measured by the IF method before the chemical strengthening treatment is preferably 1.2 or more, more preferably 1.5 or more, still more preferably 2.0 or more. When K_{c}/K_{bulk} of the glass for a substrate is less than 1.2, the need to apply the chemical strengthening treatment is meaningless.

### (3) Flatness

In the glass for a substrate subjected to the chemical strengthening treatment, the flatness is preferably 3 μm or less. The flatness as used herein indicates, for example, in the case of a 2.5-inch disk, the Peak-Valley value in the entire area between a radius of 13 mm and a radius of 32.5 mm from the center of the disk. If the flatness of the glass disk for data storage mediums exceeds 3 μM, the vibration and amplitude during rotation of the disk may be increased.

### (4) Arithmetic Average Waviness (Wa)

In the glass for a substrate subjected to the chemical strengthening treatment, the arithmetic average waviness (Wa) is preferably 0.6 nm or less, more preferably 0.5 nm or less. Here, in the case of a 2.5-inch disk, Wa indicates the arithmetic average waviness with cutoff values of 0.4 mm and 5 mm on the surface between a radius of 16 mm and a radius of 28 mm from the center of the disk. When Wa of the glass disk for data storage mediums exceeds 0.6 nm, head crash may occur.

### (5) Arithmetic Average Roughness (Ra)

The arithmetic average roughness (Ra) of the glass for a substrate subjected to the chemical strengthening treatment is preferably 0.15 nm or less, more preferably 0.14 nm or less, and especially preferably 0.12 nm or less. The “Ra” used herein means an arithmetic average roughness of an area of 10 μm×10 μm. When Ra of the glass disk for data storage mediums exceeds 0.15 nm, head crash may occur, or there is a concern that orientation of a crystal is difficult to control in film-forming a magnetic film.

### [Data Storage Medium]

In the data storage medium of the present invention, at least a magnetic layer that is a magnetic recording layer is formed on the main surface of the glass substrate for data storage mediums of the present invention and in addition, an underlayer, a protective layer, a lubricating layer, an unevenness control layer and the like may be formed, if desired.

Examples of the magnetic layer include a Co system such as Co—Cr, Co—Cr—Pt, Co—Ni—Cr, Co—Ni—Cr—Pt, Co—Ni—Pt and Co—Cr—Ta.

Examples of the underlayer provided under the magnetic layer so as to enhance the durability or magnetic property include an Ni layer, an Ni—P layer, a Cr layer and an SiO₂ layer. A Cr layer, a Cr alloy layer, or a metal or alloy layer composed of other materials may be provided on or below the magnetic layer.

Examples of the protective layer include a carbon or silica layer having a thickness of 50 to 1,000 Å. Also, in order to form a lubricating layer, for example, a perfluoropolyether-based liquid lubricant in a thickness of about 30 Å can be used.

### EXAMPLES

The present invention is described below by referring to Examples, but the present invention is not limited thereto.

### [Glass for Substrate]

Compositions of glasses for a substrate 1 to 16 used are shown in Table 1 and Table 2.

Glasses for a substrate 1 to 3 in Table 1 used glass plates obtained by a float process.

The glasses for a substrate 1 to 3 in Table 1 were prepared as follows. Glasses for a substrate were cut into a disk shape having an inner diameter of 20 mm and an outer diameter of 65 mm. The disks were subjected to a lapping step and a polishing step with cesium oxide, and then subjected to a final polishing step with colloidal silica and a cleaning step. Thus, 2.5-inch disks having a thickness of 0.635 mm, flatness of 3 μm or less, Wa of 0.60 nm or less and Ra of 0.15 nm or less were obtained, and the disks were used as samples for K_{bulk} (unit: MPa·m^{1/2}) and chemical strengthening treatment. The term “Disk” in Table 1 means a sample thus prepared.

The glasses for a substrate 4 to 16 in Tables 1 and 2 were prepared as follows. Raw materials were prepared and mixed so as to obtain compositions shown in terms of mole percent in the columns of from SiO₂ to K₂O, and melted at a temperature of from 1,550 to 1,650° C. for from 3 to 5 hours using a platinum crucible. The molten glass was flown out and molded into a plate shape, followed by annealing. Thus, glasses for a substrate were prepared.

The glasses for a substrate 4 to 16 in Tables 1 and 2 were prepared as follows. Both sides of each glass plate having a thickness of from 0.8 to 1 mm and a size of 4 cm×4 cm was mirror-polished with cerium oxide, and then cleaned with calcium carbonate and a neutral detergent. Those glass plates were used as samples for K_{bulk} and chemical strengthening treatment. The term “Plate” in Tables 1 and 2 means a sample thus prepared.

TABLE 1

| Glass for | | | | | | | | |
|---|---|---|---|---|---|---|---|---|
| Substrate | 1 | 2 | 3 | 4 | 5 | 6 | 7 | 8 |
| SiO₂ | 61.9 | 64.5 | 72 | 66.3 | 62 | 62 | 62 | 62 |
| Al₂O₃ | 13 | 12 | 1.1 | 8.5 | 13 | 13 | 13 | 13 |
| MgO | 3 | 0 | 5.5 | 0 | 3 | 3 | 3 | 3 |
| CaO | 0 | 0 | 8.6 | 0 | 0 | 0 | 0 | 0 |
| TiO₂ | 1 | 0 | 0 | 0 | 0 | 0 | 0 | 0 |
| ZrO₂ | 0.6 | 1.8 | 0 | 2.7 | 2 | 2 | 2 | 2 |
| Li₂O | 10.7 | 12.8 | 0 | 11.6 | 10 | 5 | 5 | 6.7 |
| Na₂O | 6.8 | 5.5 | 12.6 | 10.9 | 5 | 10 | 5 | 6.7 |
| K₂O | 3 | 3.4 | 0.2 | 0 | 5 | 5 | 10 | 6.6 |
| R₂O | 20.5 | 21.7 | 12.8 | 22.5 | 20 | 20 | 20 | 20 |
| Li + Na | 17.5 | 18.3 | 12.6 | 22.5 | 15 | 15 | 10 | 13.4 |
| Li/R₂O | 0.52 | 0.59 | 0.00 | 0.52 | 0.50 | 0.25 | 0.25 | 0.34 |
| Tg | 520 | 514 | 550 | 490 | 556 | 569 | 588 | 563 |
| α | 73 | 74 | 72 | 73 | 73 | 80 | 83 | 80 |
| d | 2.47 | 2.47 | 2.50 | 2.50 | 2.49 | 2.51 | 2.50 | 2.50 |
| E | 83.2 | 82.7 | 83.1 | 84.0 | 84.3 | 81.4 | 79.0 | 81.6 |
| E/d | 33.7 | 33.5 | 28.8 | 33.6 | 33.8 | 32.5 | 31.6 | 32.7 |
| T₄ | 1087 | 1093 | 1040 | — | — | — | — | — |
| T_{L} | <960 | 1050 | 1020 | — | <1040 | — | — | — |
| K_{bulk} | 0.94 | 0.93 | 0.78 | 0.88 | 0.89 | 0.78 | 0.72 | 0.81 |
| Form | Disk | Disk | Disk | Plate | Plate | Plate | Plate | Plate |

(Mol % indication in terms of oxides)

TABLE 2
(Mol % indication in terms of oxides)

| Glass for | | | | | | | | |
|---|---|---|---|---|---|---|---|---|
| Substrate | 9 | 10 | 11 | 12 | 13 | 14 | 15 | 16 |
| SiO₂ | 62 | 62 | 63.5 | 65 | 57 | 64 | 60 | 64 |
| Al₂O₃ | 13 | 13 | 11.5 | 10 | 13 | 13 | 13 | 13 |
| MgO | 3 | 3 | 3 | 3 | 3 | 3 | 5 | 3 |
| CaO | 0 | 0 | 0 | 0 | 0 | 0 | 0 | 0 |
| TiO₂ | 0 | 0 | 0 | 0 | 0 | 0 | 0 | 0 |
| ZrO₂ | 2 | 2 | 2 | 2 | 2 | 2 | 2 | 0 |
| Li₂O | 7.5 | 9 | 10 | 10 | 12.5 | 9 | 10 | 10 |
| Na₂O | 7.5 | 6 | 5 | 5 | 6.25 | 4.5 | 5 | 5 |
| K₂O | 5 | 5 | 5 | 5 | 6.25 | 4.5 | 5 | 5 |
| R₂O | 20 | 20 | 20 | 20 | 25 | 18 | 20 | 20 |
| Li + Na | 15 | 15 | 15 | 15 | 18.75 | 13.5 | 15 | 15 |
| Li/R₂O | 0.38 | 0.45 | 0.50 | 0.50 | 0.50 | 0.50 | 0.50 | 0.50 |
| Tg | 557 | 553 | 537 | 519 | 508 | 584 | 557 | 519 |
| α | 76 | 74 | 73 | 73 | 83 | 68 | 73 | 72 |
| d | 2.50 | 2.50 | 2.49 | 2.46 | 2.59 | 2.50 | 2.48 | 2.44 |
| E | 83.0 | 83.8 | 83.7 | 82.4 | 88.4 | 84.9 | 84.0 | 82.8 |
| E/d | 33.2 | 33.6 | 33.6 | 33.4 | 34.2 | 33.9 | 33.9 | 33.9 |
| T₄ | — | — | — | — | — | — | — | — |
| T_{L} | — | — | — | — | — | — | — | — |
| K_{bulk} | 0.85 | 0.83 | 0.87 | 0.88 | 0.81 | 0.89 | 0.85 | 0.96 |
| Form | Plate | Plate | Plate | Plate | Plate | Plate | Plate | Plate |

### [Mixed Molten Salt]

Compositions of mixed molten salts 1 to 17 used in the chemical strengthening treatment are shown in Tables 3 and 4. The mixed molten salts 1 to 17 in Tables 3 and 4 were prepared as follows. 1 to 2 kg of raw materials were prepared and mixed so as to obtain compositions shown in terms of mass percent in the columns of from lithium nitrate to potassium nitrate, and melted and stirred at 450° C. using a SUS vessel. The molten mixture was held at a given treatment temperature, and when the temperature was stabilized, chemical strengthening was performed. A melting point (M.P) was measured as follows. The chemical strengthening mixed molten salt, a part of which having been solidified, was pulverized to form a powder, and the melting of the powder was measured with differential scanning calorimetry (DSC). The expression “-” in Tables 3 and 4 means that measurement was not performed.

TABLE 3
(% by mass)

| Mixed molten | | | | | | | | |
|---|---|---|---|---|---|---|---|---|
| salt | 1 | 2 | 3 | 4 | 5 | 6 | 7 | 8 |
| LiNO₃ | 0.0 | 0.0 | 0.0 | 0.0 | 0.4 | 1.5 | 3.7 | 3.7 |
| NaNO₃ | 0.0 | 21.9 | 45.7 | 71.6 | 45.7 | 51.0 | 41.5 | 31.7 |
| KNO₃ | 100.0 | 78.1 | 54.3 | 28.4 | 53.9 | 47.5 | 54.8 | 64.6 |
| M.P. (° C.) | 335 | 262 | 223 | 251 | — | — | 202 | 215 |

TABLE 4
(% by mass)

| Mixed | | | | | | | | | |
|---|---|---|---|---|---|---|---|---|---|
| molten | | | | | | | | | |
| salt | 9 | 10 | 11 | 12 | 13 | 14 | 15 | 16 | 17 |
| LiNO₃ | 3.8 | 4.0 | 5.3 | 6.8 | 7.5 | 7.8 | 11.4 | 19.4 | 20.3 |
| NaNO₃ | 51.6 | 41.7 | 42.8 | 44.6 | 37.2 | 57.8 | 32.8 | 23.9 | 50.0 |
| KNO₃ | 44.6 | 54.2 | 52.0 | 48.6 | 55.3 | 34.4 | 55.8 | 56.8 | 29.7 |
| M.P. | 213 | — | — | — | 175 | 211 | 137 | 148 | 109 |
| (° C.) | | | | | | | | | |

### [Evaluation Method]

Tg (unit: ° C.), α (unit: ×10⁻⁷/° C.), density d (unit: g/cm³), Young's modulus E (unit: GPa), specific modulus E/d (unit: MNm/kg), temperature T₄ (unit: ° C.) at which viscosity is 10⁴ P, liquidus temperature T_{L} (unit: ° C.) and K_{bulk} (unit: MPa·m^{1/2}) of a glass for a substrate were measured or evaluated by the following methods.

### (1) Glass Transition Temperature (Tg) (Unit: ° C.)

Using a differential thermal dilatometer and using quartz glass as a reference sample, the elongation percentage of glass when heated from room temperature at a rate of 5° C./min was measured up to a temperature at which the glass was softened and elongation was no longer observed, that is, a deformation point, and the temperature corresponding to the inflection point in the thermal expansion curve was taken as the glass transition temperature.

### (2) Average Coefficient of Linear Expansion (α) (Unit: ×10⁻⁷/° C.)

From the thermal expansion curve obtained in the same manner as in the measurement of Tg above after lowering the sample temperature to the vicinity of −150° C. by using liquid nitrogen, the average coefficient of linear expansion in the range of −50 to 70° C. was calculated.

(3) Density (d) (Unit: g/cm³)

Measured by the Archimedes method.

### (4) Young's Modulus (E) (Unit: GPa)

With respect to a glass plate having a thickness of 4 to 10 mm and a size of about 4 cm×4 cm, the Young's modulus was measured by the ultrasonic pulse method.

### (5) Temperature (T₄) at Which the Viscosity Becomes 10⁴ P (Unit: ° C.)

The temperature at which the viscosity becomes 10⁴ P was measured by a rotation viscometer and designated as T₄.

### (6) Liquidus Temperature (T_{L}) (Unit: ° C.)

T_{L}: A glass specimen of about 1 cm×1 cm×0.8 cm was placed on a platinum dish and heat-treated for 3 hours in an electric furnace set at every 20° C. in the temperature range of 960 to 1,200° C. The glass was allowed to cool in atmospheric air and then observed by a microscope, and the temperature range where a crystal was precipitated was taken as the liquidus temperature.

(7) Fracture Toughness Value (K_{bulk}) (Unit: MPa·m^{1/2})

Using the sample above, the fracture toughness value was determined by the IF method in accordance with JIS R1607. That is, an operation of introducing an indentation mark with an indentation load of 5 kgf for a holding time of 15 seconds by using a Vickers hardness tester and after standing for 15 seconds, measuring the diagonal length of indentation mark and the length of crack by using a microscope attached to the tester, was repeated 10 times, and the fracture toughness value was obtained according to the following formula:

K_{C}=0.026×(E×P)^{1/2}×a×c^{-3/2}

In the formula, E is the Young's modulus and the value measured by the method above was used. Also, P is the indentation load, a is a half of the average diagonal length of the indentation mark, and c is a half of the average crack length.

K_{c} (unit: MPa·m^{1/2}), flatness (unit: cm), Wa (unit: nm) and Ra (unit nm) of the glass for a substrate subjected to the chemical strengthening treatment were measured or evaluated.

(8) Fracture Toughness Value (K_{c}) (Unit: MPa·m^{1/2})

Measured in the same manner as in (7).

### (9) Flatness (Unit: μm)

The Peak-Valley value in the entire area between a radius of 13 mm and a radius of 32.5 mm from the center of the disk was measured using Optiflat.

### (10) Arithmetic Average Waviness (Wa) (Unit: nm)

The arithmetic average waviness with cutoff values of 0.4 mm and 5 mm on the surface between a radius of 16 mm and a radius of 28 mm from the center of the disk was measured using Optiflat.

### (11) Arithmetic Average Roughness (Ra) (Unit: nm)

Arithmetic average roughness of the area of 10 μm×10 μm was measured using an atomic force microscope (AFM).

### Reference Example 1

Glasses for a substrate 1 to 16, having compositions shown in Tables 1 and 2 were dipped in the mixed molten salt 3 having the composition shown in Table 3, which is a composition near the eutectic point of sodium nitrate and potassium nitrate generally used, at 400° C. for 0.5 hour, thereby subjecting to the chemical strengthening treatment.

The results of evaluating the characteristics of the glasses for a substrate subjected to the chemical strengthening treatment are shown in Tables 5 and 6. In Tables 5 and 6, Run Nos. 1 to 16 are reference examples. The mark “-” in Tables 5 and 6 indicates that measurement was not performed. Furthermore, in Tables 5 and 6, the values in the parenthesis indicate estimated values.

TABLE 5

| | Run No. | | | | | | | |
|---|---|---|---|---|---|---|---|---|
| | 1 | 2 | 3 | 4 | 5 | 6 | 7 | 8 |
| Glass for a substrate | 1 | 2 | 3 | 4 | 5 | 6 | 7 | 8 |
| Mixed molten salt | 3 | 3 | 3 | 3 | 3 | 3 | 3 | 3 |
| Treatment temperature (° C.) | 400 | 400 | 400 | 400 | 400 | 400 | 400 | 400 |
| Treatment time (min) | 30 | 30 | 30 | 30 | 30 | 30 | 30 | 30 |
| Preheating condition (° C.) | — | — | — | — | — | — | — | — |
| Annealing and quenching conditions | 1500 | 1500 | 1500 | 1500 | 1500 | 1500 | 1500 | 1500 |
| (° C.) | | | | | | | | |
| K_{c} | 1.88 | 1.86 | 0.74 | 1.59 | 1.92 | 1.63 | 0.91 | 1.67 |
| K_{c}/K_{bulk} | 2.0 | 2.0 | 0.95 | 1.81 | 2.16 | 2.09 | 1.26 | 2.06 |

TABLE 6

| | Example | | | | | | | |
|---|---|---|---|---|---|---|---|---|
| | 9 | 10 | 11 | 12 | 13 | 14 | 15 | 16 |
| Glass for a substrate | 9 | 10 | 11 | 12 | 13 | 14 | 15 | 16 |
| Mixed molten salt | 3 | 3 | 3 | 3 | 3 | 3 | 3 | 3 |
| Treatment temperature (° C.) | 400 | 400 | 400 | 400 | 400 | 400 | 400 | 400 |
| Treatment time (min) | 30 | 30 | 30 | 30 | 30 | 30 | 30 | 30 |
| Preheating condition (° C.) | — | — | — | — | — | — | — | — |
| Annealing and quenching conditions | 1500 | 1500 | 1500 | 1500 | 1500 | 1500 | 1500 | 1500 |
| (° C.) | | | | | | | | |
| K_{c} | (1.7) | (1.8) | (1.8) | (1.7) | (1.5) | (2.2) | (1.7) | (1.7) |
| K_{c}/K_{bulk} | (2.0) | (2.2) | (2.1) | (1.9) | (1.9) | (2.3) | (2.0) | (1.8) |

As shown in Tables 5 and 6, it was found that as a result of the chemical strengthening treatment, Li₂O-free glass for a substrate 3 has low K_{c} value as compared with Li₂O-containing glass for a substrate, and therefore, the glass for a substrate 3 is difficult to be chemically strengthened. Furthermore, the glasses for a substrate 1, 2, 5, 10, 11 and 14, comprising, in terms of mol % on the basis of oxides, from 58 to 66% of SiO₂, from 11 to 17% of Al₂O₃, from 0 to 4% of MgO, from 8 to 16% of Li₂O, and from 2 to 9% of Na₂O, provided that Li₂O+Na₂O is from 13 to 21%, and satisfying the requirement that the value obtained by dividing the content (in terms of mol % on the basis of oxides) of Li₂O by the total content of Li₂O, K₂O and Na₂O is 0.4 or more, had high K_{c} value as compared with Run Nos. 3, 4, 6 to 9, 12, 13 and 15 that do not satisfy the requirement. Run No. 16 satisfying the requirement showed the same level of K_{c} value as in Run Nos. 9, 12 and 15. It was found from those results that the glasses for a substrate, satisfying the requirement are liable to be chemically strengthened.

### Example 1

The glass for a substrate 1 in Table 1 was subjected to the chemical strengthening treatment under the conditions shown in Tables 7 to 9. The preheating was conducted at the temperature shown in the Tables for 10 minutes, and the indication “-” in the Tables indicates that preheating was not conducted. The cooling condition was controlled by a cooling initiation temperature, a cooling medium temperature (water, hot water and the like), and if necessary, by using an annealing furnace. Thereafter, characteristics of the glass for a substrate having been subjected to the chemical strengthening treatment and the glass disk were evaluated. The results obtained are shown in Tables 7 to 9. Run Nos. 1 to 14 in Tables 7 and 8 are Reference Examples, Run Nos. 15 to 17 and 21 in Table 9 are Comparative Examples, and Run Nos. 18 to 20 in Table 9 are Examples. The indication “-” in Tables 7 to 9 indicates that measurement was not performed.

TABLE 7

| | Run | | | | | | |
|---|---|---|---|---|---|---|---|
| | 1 | 2 | 3 | 4 | 5 | 6 | 7 |
| Glass for a substrate | 1 | 1 | 1 | 1 | 1 | 1 | 1 |
| Mixed molten salt | 1 | 2 | 3 | 4 | 5 | 6 | 7 |
| Treatment temperature | 350 | 350 | 350 | 350 | 350 | 350 | 350 |
| (° C.) | | | | | | | |
| Treatment time (min) | 120 | 120 | 120 | 120 | 120 | 60 | 120 |
| CSC | 2700 | 2700 | 2700 | 2700 | 2700 | 2489 | 2700 |
| Preheating condition (° C.) | — | — | — | — | — | 300 | — |
| Annealing and quenching | 1500 | 1500 | 1500 | 1500 | 1500 | 1500 | 1500 |
| conditions (° C./min) | | | | | | | |
| K_{c} (MPa · m^{1/2}) | 1.18 | 1.96 | 1.83 | 2 | 1.61 | 1.58 | 1.57 |
| K_{c}/K_{bulk} | 1.26 | 2.09 | 1.95 | 2.13 | 1.72 | 1.68 | 1.67 |
| Flatness (μm) | 1.79 | 7.45 | 6.95 | 6.92 | 0.63 | 2.37 | 0.92 |
| Wa (nm) | — | >10.00 | >10.00 | >10.00 | 0.62 | 0.63 | 0.33 |

TABLE 8

| | Run | | | | | | |
|---|---|---|---|---|---|---|---|
| | 8 | 9 | 10 | 11 | 12 | 13 | 14 |
| Glass for a substrate | 1 | 1 | 1 | 1 | 1 | 1 | 1 |
| Mixed molten salt | 8 | 9 | 13 | 14 | 15 | 16 | 17 |
| Treatment temperature (° C.) | 350 | 350 | 350 | 350 | 350 | 350 | 350 |
| Treatment time (min) | 120 | 120 | 120 | 120 | 120 | 120 | 120 |
| CSC | 2700 | 2700 | 2700 | 2700 | 2700 | 2700 | 2700 |
| Preheating condition (° C.) | — | — | — | — | — | — | — |
| Annealing and quenching | 1500 | 1500 | 1500 | 1500 | 1500 | 1500 | 1500 |
| conditions (° C./min) | | | | | | | |
| K_{c} (MPa · m^{1/2}) | 1.6 | 1.62 | 1.31 | 1.16 | 0.89 | 0.55 | 0.58 |
| K_{c}/K_{bulk} | 1.70 | 1.72 | 1.39 | 1.23 | 0.95 | 0.59 | 0.62 |
| Flatness (μm) | 0.91 | 1.42 | 1.2 | 2.4 | 1.7 | 1.05 | 0.97 |
| Wa (nm) | 0.44 | — | — | — | — | — | — |

TABLE 9

| | Run | | | | | | |
|---|---|---|---|---|---|---|---|
| | 15 | 16 | 17 | 18 | 19 | 20 | 21 |
| Glass for a substrate | 1 | 1 | 1 | 1 | 1 | 1 | 1 |
| Mixed molten salt | 1 | 3 | 5 | 6 | 10 | 11 | 12 |
| Treatment temperature (° C.) | 400 | 400 | 400 | 400 | 400 | 400 | 400 |
| Treatment time (min) | 10 | 10 | 10 | 10 | 10 | 10 | 10 |
| CSC | 2223 | 2223 | 2223 | 2223 | 2223 | 2223 | 2223 |
| Preheating condition (° C.) | 300 | 300 | 300 | 300 | 300 | 300 | 300 |
| Annealing and quenching | 1500 | 1500 | 1500 | 1500 | 1500 | 1500 | 1500 |
| conditions (° C./min) | | | | | | | |
| K_{c} (MPa · m^{1/2}) | 1.11 | 1.42 | 1.36 | 1.28 | 1.24 | 1.21 | 1.14 |
| K_{c}/K_{bulk} | 1.18 | 1.51 | 1.45 | 1.36 | 1.32 | 1.29 | 1.21 |
| Flatness (μm) | 4.62 | 3.25 | 0.63 | 1.11 | — | — | — |
| Wa (nm) | 1.27 | 1.49 | 0.82 | 0.55 | — | — | — |
| Ra (nm) | — | — | — | — | — | — | — |

As shown in Tables 7 and 8, Run Nos. 6 to 9 that were subjected to the chemical strengthening treatment using the mixed molten salts 6 to 9 containing from 1 to 6% by mass of lithium nitrate had good K_{c} value or Wa value as compared with Run Nos. 1 to 5 and 10 to 14.

Furthermore, as shown in Table 9, Run Nos. 18 to 20 that were subjected to the chemical treatment using the mixed molten salt 6, 10 or 11 containing from 1 to 6% by mass of lithium nitrate had good K_{c} value or Wa value as compared with Run Nos. 15 to 17 and 21.

It was found from those results that the mixed molten salt containing from 1 to 6% by mass of lithium nitrate is suitable for the chemical strengthening treatment of the lithium ion-containing glass for a substrate.

### Example 2

The glasses for a substrate were subjected to the chemical strengthening treatment by varying the dipping temperature between 3 minutes and 120 minutes at the temperature of dipping the glasses for a substrate in the mixed molten salt between 350° C. and 450° C. under the conditions shown in Tables 10 to 13. The preheating was conducted at the temperature shown in the Tables for 10 minutes, and the indication “-” in the Tables indicates that the preheating was not conducted. The cooling condition was controlled by a cooling initiation temperature, a cooling medium temperature (water, hot water and the like), and if necessary, by using an annealing furnace.

The results of evaluating the characteristics of the glasses for a substrate subjected to the chemical strengthening treatment are shown in Tables 10 to 13. The indication “-” in Tables 10 to 13 indicates that measurement was not performed. In Tables 10 to 13, Run Nos. 1 to 5, 9, 11-20 and 24-28 are Examples, Run Nos. 6 to 8, 10, 21 to 23 and 29 to 32 are Comparative Examples.

TABLE 10

| | Run | | | | | | | | |
|---|---|---|---|---|---|---|---|---|---|
| | 1 | 2 | 3 | 4 | 5 | 6 | 7 | 8 | 9 |
| Glass for a substrate | 1 | 1 | 1 | 1 | 2 | 1 | 1 | 1 | 1 |
| Mixed molten salt | 6 | 7 | 6 | 7 | 7 | 6 | 7 | 7 | 7 |
| Treatment temperature | 350 | 350 | 350 | 350 | 350 | 350 | 350 | 375 | 375 |
| (° C.) | | | | | | | | | |
| Treatment time (min) | 10 | 10 | 30 | 30 | 30 | 60 | 60 | 5 | 10 |
| CSC | 1945 | 1945 | 2279 | 2279 | 2279 | 2489 | 2489 | 1858 | 2084 |
| Preheating condition | 300 | 300 | 300 | 300 | 300 | 300 | 300 | 300 | 300 |
| (° C.) | | | | | | | | | |
| Annealing and | 1500 | 1500 | 1500 | 1500 | 1500 | 1500 | 1500 | 1500 | 1500 |
| quenching conditions | | | | | | | | | |
| (° C./min) | | | | | | | | | |
| K_{c} (MPa · m^{1/2}) | 1.26 | 1.26 | 1.24 | 1.25 | 1.27 | 1.58 | 1.42 | 1.16 | 1.2 |
| K_{c}/K_{bulk} | 1.34 | 1.35 | 1.32 | 1.33 | 1.37 | 1.68 | 1.51 | 1.23 | 1.28 |
| Flatness (μm) | 1.78 | 1.15 | 1.99 | 1.41 | 1 | 2.37 | 2.33 | — | — |
| Wa (nm) | 0.58 | 0.43 | 0.52 | 0.57 | 0.43 | 0.63 | 0.63 | — | — |
| Ra (nm) | — | — | — | — | — | — | — | — | — |

TABLE 11

| | Run | | | | | | |
|---|---|---|---|---|---|---|---|
| | 10 | 11 | 12 | 13 | 14 | 15 | 16 |
| Glass for a substrate | 1 | 1 | 1 | 1 | 1 | 1 | 2 |
| Mixed molten salt | 7 | 7 | 7 | 6 | 7 | 10 | 7 |
| Treatment temperature (° C.) | 400 | 400 | 400 | 400 | 400 | 400 | 400 |
| Treatment time (min) | 3 | 5 | 7 | 10 | 10 | 10 | 10 |
| CSC | 1804 | 1982 | 2099 | 2223 | 2223 | 2223 | 2223 |
| Preheating condition (° C.) | 300 | 300 | 300 | 300 | 300 | 300 | 300 |
| Annealing and quenching | 1500 | 1500 | 1500 | 1500 | 1500 | 1500 | 1500 |
| conditions (° C./min) | | | | | | | |
| K_{c} (MPa · m^{1/2}) | 1.16 | 1.23 | 1.3 | 1.28 | 1.32 | 1.24 | 1.47 |
| K_{c}/K_{bulk} | 1.23 | 1.31 | 1.38 | 1.36 | 1.40 | 1.32 | 1.58 |
| Flatness (μm) | — | — | — | 1.11 | 1.09 | — | 2.15 |
| Wa (nm) | — | — | — | 0.55 | 0.43 | — | 0.43 |
| Ra (nm) | — | — | — | — | 0.11 | — | — |

TABLE 12

| | Run | | | | | | |
|---|---|---|---|---|---|---|---|
| | 17 | 18 | 19 | 20 | 21 | 22 | 23 |
| Glass for a substrate | 1 | 2 | 1 | 2 | 1 | 1 | 1 |
| Mixed molten salt | 6 | 6 | 7 | 7 | 6 | 7 | 7 |
| Treatment temperature (° C.) | 400 | 400 | 400 | 400 | 400 | 400 | 400 |
| Treatment time (min) | 30 | 30 | 30 | 30 | 60 | 60 | 120 |
| CSC | 2604 | 2604 | 2604 | 2604 | 2845 | 2845 | 3086 |
| Preheating condition (° C.) | 300 | 300 | — | 300 | 300 | — | — |
| Annealing and quenching | 1500 | 1500 | 1500 | 1500 | 1500 | 1500 | 1500 |
| conditions (° C./min) | | | | | | | |
| K_{c} (MPa · m^{1/2}) | 1.45 | 1.57 | 1.62 | 1.5 | 1.73 | 1.7 | — |
| K_{c}/K_{bulk} | 1.54 | 1.69 | 1.72 | 1.61 | 1.84 | 1.81 | — |
| Flatness (μm) | 1.93 | 0.65 | 0.68 | 1.71 | 0.87 | 1.42 | 2.72 |
| Wa (nm) | 0.56 | 0.46 | 0.44 | 0.47 | 0.79 | 0.61 | 0.74 |
| Ra (nm) | — | — | 0.12 | — | — | 0.13 | 0.16 |

TABLE 13

| | Run | | | | | | | | |
|---|---|---|---|---|---|---|---|---|---|
| | 24 | 25 | 26 | 27 | 28 | 29 | 30 | 31 | 32 |
| Glass for a substrate | 1 | 1 | 1 | 1 | 2 | 1 | 1 | 1 | 1 |
| Mixed molten salt | 7 | 6 | 7 | 7 | 7 | 6 | 7 | 6 | 7 |
| Treatment temperature | 425 | 450 | 450 | 450 | 450 | 450 | 450 | 450 | 450 |
| (° C.) | | | | | | | | | |
| Treatment time (min) | 5 | 10 | 3 | 10 | 10 | 30 | 30 | 60 | 60 |
| CSC | 2106 | 2500 | 2030 | 2500 | 2500 | 2930 | 2930 | 3201 | 3201 |
| Preheating condition (° C.) | 300 | 300 | 300 | 300 | 300 | 300 | 300 | 300 | 300 |
| Annealing and quenching | 1500 | 1500 | 1500 | 1500 | 1500 | 1500 | 1500 | 1500 | 1500 |
| conditions (° C./min) | | | | | | | | | |
| K_{c} (MPa · m^{1/2}) | 1.31 | 1.62 | 1.27 | 1.59 | 1.66 | 1.86 | 1.82 | 2.48 | 2.06 |
| K_{c}/K_{bulk} | 1.39 | 1.72 | 1.35 | 1.69 | 1.78 | 1.98 | 1.94 | 2.64 | 2.19 |
| Flatness (μm) | — | 2.98 | — | 1.75 | 1.34 | 3.75 | 1.32 | 4.95 | 2.31 |
| Wa (nm) | — | 0.58 | — | 0.57 | 0.48 | 0.89 | 0.68 | 0.81 | 0.85 |
| Ra (nm) | — | — | — | — | — | — | — | — | — |

As shown in Tables 10 to 13, Run Nos. 8 and 10 having the conditions of the chemical strengthening temperature and time that CSC values are less than 1,900 had K_{c} value of 1.2 or less. On the other hand, Run No. 26 in which the treatment time is 3 minutes and the treatment temperature is 450° C. has the CSC value exceeding 2,000 even though the treatment time is short, and therefore, sufficient strengthening was performed.

As shown in Tables 10 to 13, Run Nos. 6, 7, 21 to 23 and 29 to 32 in which the time of dipping the glass for a substrate in the mixed molten salt exceeds 30 minutes had high Wa value as compared with Run Nos. 1 to 5, 13, 14, 16 to 20, 25, 27 and 28. Furthermore, Even though the dipping time is 30 minutes or shorter, Run Nos. 29 and 30 in which the CSC value exceeds 2,900 had high Wa value as compared with Run Nos. 1 to 5, 13, 14, 16 to 20, 25, 27 and 28.

As shown in Table 13, the flatness values of Run Nos. 25, 29 and 31 in which the chemical strengthening treatment temperature is 450° C. and the mixed molten salt is No. 6 were high as compared with Run Nos. 27, 28, 30 and 32 in which the glass was treated with the mixed molten salt No. 7 having high lithium nitrate content at the same treatment temperature. It was found from those results that the flatness has a correlation with the treatment temperature and the content of lithium nitrate in the mixed molten salt.

As shown in Tables 11 and 12, Ra of Run No. 23 was high as compared with Run Nos. 14, 19 and 22 in which the treatment time is shorter than that of Run No. 23. It was found from this result that Ra has a correlation with the treatment time.

It was found from those results that of the flatness, Wa and Ra, the most sensitive factor to the treatment temperature and the treatment time, of dipping the glass for a substrate in the mixed molten salt is Wa. It was further found that when the treatment time is a range of from 325° C. to 475° C., the treatment time is 30 minutes or shorter and the CSC value is 2,900 or less, Wa of the glass for a substrate after the chemical strengthening treatment is suppressed to 0.6 nm or less.

It was therefore seen that when the treatment temperature of dipping the glass for a substrate in the mixed molten salt is a range of 325° C. or more and 475° C. or less, the treatment time is 30 minutes or shorter and the CSC value is between 1,900 and 2,900, the strengthening is sufficient and the shape is stabilized.

### Example 3

The glass for a substrate 1 was chemically strengthened using the mixed molten salt No. 7 under the conditions shown in Table 14, and then annealed and quenched. The preheating was conducted at the temperature shown in the Table for 10 minutes, and the indication “-” in the Table indicates that the preheating was not conducted. The cooling condition was controlled by cooling initiation temperature, cooling medium temperature (water, hot water and the like), and if necessary, by using an annealing furnace.

The results of evaluating the characteristics of the glass for a substrate subjected to the chemical strengthening treatment are shown in Table 14. Runs 1 to 11 of Table 14 are examples.

TABLE 14

| | Run | | | | | | | | | | |
|---|---|---|---|---|---|---|---|---|---|---|---|
| | 1 | 2 | 3 | 4 | 5 | 6 | 7 | 8 | 9 | 10 | 11 |
| Glass for a substrate | 1 | 1 | 1 | 1 | 2 | 1 | 1 | 1 | 1 | 1 | 1 |
| Mixed molten salt | 7 | 7 | 7 | 7 | 7 | 7 | 7 | 7 | 7 | 7 | 7 |
| Treatment temperature (° C.) | 40 | 400 | 400 | 400 | 400 | 400 | 400 | 400 | 400 | 400 | 400 |
| Treatment time (min) | 30 | 30 | 30 | 30 | 30 | 10 | 20 | 20 | 10 | 10 | 10 |
| Preheating condition (° C.) | — | 300 | 400 | 300 | 300 | 300 | 300 | 300 | 300 | 300 | 300 |
| Annealing and quenching | 1500 | 1500 | 1500 | 1 | 5 | 500 | 1000 | 1500 | 1500 | 3600 | 4800 |
| conditions (° C./min) | | | | | | | | | | | |
| K_{c} (MPa · m^{1/2}) | 1.62 | 1.64 | — | 1.76 | — | — | 1.43 | 1.54 | 1.32 | — | — |
| K_{c}/K_{bulk} | 1.72 | 1.74 | — | 1.87 | — | — | 1.52 | 1.64 | 1.40 | — | — |
| Flatness (μm) | 0.68 | 0.78 | 3.84 | >10.00 | 9.83 | 1.49 | 2.11 | 0.81 | 1.09 | 1.44 | 2.27 |
| Wa (nm) | 0.44 | — | — | — | 16.43 | 0.51 | 0.43 | 0.32 | 0.43 | 0.41 | 2.32 |
| Ra (nm) | 0.12 | — | — | — | — | — | — | — | 0.11 | — | — |

As shown in Table 14, Run No. 2 using the preheated mixed molten salt had high Kc as compared with Run No. 1 in which the chemical strengthening treatment was performed without preheating the mixed molten salt. Furthermore, Run No. 3 using the mixed molten salt preheated at 400° C. had high flatness value as compared with Run No. 4 using the mixed molten salt preheated at 300° C. It was found from those results that K_{c} is improved by performing the chemical strengthening treatment using the preheated mixed molten salt, and the shape of the glass for a substrate is stabilized when the preheating temperature is lower than 400° C.

It was found from the results of Run Nos. 3 to 5 that when the glass for a substrate is quenched after the chemical strengthening treatment, the shape of the glass for a substrate is stabilized. It was further found from the results of Run Nos. 5 to 11 that when the cooling rate of the glass for a substrate exceeds 4,000° C./min, Wa and Ra values are increased.

### Example 4

The chemical strengthening treatment was performed by combining the glass for a substrate and the mixed molten salt as shown in Tables 15 and 16. The cooling condition was controlled by cooling initiation temperature, cooling medium temperature (water, hot water and the like), and if necessary, by using an annealing furnace.

The results of evaluating the characteristics of the glasses for a substrate subjected to the chemical strengthening treatment are shown in Tables 15 and 16. The indication “-” in Tables 15 and 16 indicates that measurement was not performed. In Tables 15 and 16, Run Nos. 5 to 18 are Examples, and Run Nos. 1 to 4 are Comparative Examples. The indication “x” in the column of K_{c} indicates that a tensile layer is formed on the surface layer during chemical strengthening or cleaning, resulting in self-destruction, and K_{c} could not be measured.

TABLE 15

| | Run | | | | | | | | | |
|---|---|---|---|---|---|---|---|---|---|---|
| | 1 | 2 | 3 | 4 | 5 | 6 | 7 | 8 | 9 | 10 |
| Glass for a substrate | 3 | 3 | 3 | 3 | 4 | 5 | 6 | 7 | 8 | 9 |
| Mixed molten salt | 1 | 2 | 3 | 7 | 7 | 7 | 7 | 7 | 7 | 7 |
| Treatment temperature (° C.) | 400 | 400 | 400 | 400 | 400 | 400 | 400 | 400 | 400 | 400 |
| Treatment time (min) | 30 | 30 | 30 | 30 | 30 | 30 | 30 | 30 | 30 | 30 |
| CSC | 2604 | 2604 | 2604 | 2604 | 2604 | 2604 | 2604 | 2604 | 2604 | 2604 |
| Preheating condition (° C.) | — | — | — | — | — | — | — | — | — | — |
| Annealing and quenching | 1500 | 1500 | 1500 | 1500 | 1500 | 1500 | 1500 | 1500 | 1500 | 1500 |
| conditions (° C./min) | | | | | | | | | | |
| K_{c} (MPa · m^{1/2}) | 0.83 | 0.76 | 0.74 | x | 1.11 | 1.36 | 0.7 | x | 0.97 | 1.05 |
| K_{c}/K_{bulk} | 1.06 | 0.97 | 0.95 | — | 1.26 | 1.53 | 0.90 | — | 1.20 | 1.24 |
| Flatness (μm) | — | — | — | — | — | — | — | — | — | |
| Wa (nm) | — | — | — | — | — | — | — | — | — | |
| Ra (nm) | — | — | — | — | — | — | — | — | — | |

TABLE 16

| | Run | | | | | | | |
|---|---|---|---|---|---|---|---|---|
| | 11 | 12 | 13 | 14 | 15 | 16 | 17 | 18 |
| Glass for a substrate | 10 | 11 | 11 | 12 | 13 | 14 | 15 | 16 |
| Mixed molten salt | 7 | 7 | 6 | 7 | 7 | 7 | 7 | 7 |
| Treatment temperature (° C.) | 400 | 400 | 400 | 400 | 400 | 400 | 400 | 400 |
| Treatment time (min) | 30 | 30 | 30 | 30 | 30 | 30 | 30 | 30 |
| CSC | 2604 | 2604 | 2604 | 2604 | 2604 | 2604 | 2604 | 2604 |
| Preheating condition (° C.) | — | — | — | — | — | — | — | — |
| Annealing and quenching | 1500 | 1500 | 1500 | 1500 | 1500 | 1500 | 1500 | 1500 |
| conditions (° C./min) | | | | | | | | |
| K_{c} (MPa · m^{1/2}) | 1.23 | 1.22 | 1.37 | 1.12 | 0.86 | 1.51 | 1.18 | 1.32 |
| K_{c}/K_{bulk} | 1.48 | 1.40 | 1.57 | 1.27 | 1.06 | 1.70 | 1.39 | 1.38 |
| Flatness (μm) | — | — | — | — | — | — | — | |
| Wa (nm) | — | — | — | — | — | — | — | |
| Ra (nm) | — | — | — | — | — | — | — | |

As shown in Table 15, Run No. 6 using Li₂O-containing glass for a substrate 5 had K_{c} value of 1.2 or more, whereas Run No. 4 using Li₂O-free glass for a substrate 3 was that a tensile layer is formed on a surface layer during chemical strengthening or cleaning, resulting in self-destruction, and K_{c} could not be measured. Furthermore, Run Nos. 7 to 10 using the glasses for a substrate in which the content of Li₂O is less than 8% in terms of mol % on the basis of oxides had low K_{c} value as compared with Run No. 11 using the glass for a substrate containing 9% of Li₂O, or measurement of K_{c} was impossible. The reason for this is that strengthening development in the present invention is due to ion exchange between Li⁺ and Na⁺. It was found from those results that the content of Li₂O in the glass for a substrate is preferably 8% in terms of mol % on the basis of oxides.

Run Nos. 7 to 10 using the glasses for a substrate 6 to 9 f in which the value obtained by dividing the content (in terms of mol % on the basis of oxides) of Li₂O by the total content (R₂O) of Li₂O, Na₂O and K₂O is less than 0.4 had low K_{c} value as compared with Run No. 11 using the glass for a substrate 10 having the value of 0.4 or more. The reason for this is that strengthening development in the present invention is due to ion exchange between Li⁺ and Na⁺. When the contents of Na and K in the glass for a substrate are large, the ion exchange is inhibited. On the other hand, when Li⁺ enters the glass for a substrate, strength is decreased. It was found from this result that the value obtained by dividing the content (in terms of mol % on the basis of oxides) of Li₂O in the glass for a substrate by the total content (R₂O) of Li₂O, Na₂O and K₂O is preferably 0.4 or more.

Run Nos. 5 and 14 using the glasses for a substrate 4 and 12 in which Al₂O₃ content is less than 11% in terms of mol % on the basis of oxides had low K_{c} value as compared with Run No. 12 using the glass for a substrate 11 in which Al₂O₃ content is 11% or more. The reason for this is that Al₂O₃ has the effect of accelerating ion exchange rate. It was found from the result that Al₂O₃ content in the glass for a substrate is preferably 11% in terms of mol % on the basis of oxides.

Run No. 15 using the glass for a substrate 13 in which SiO₂ content is less than 58% in terms of mol % on the basis of oxides had low K_{c} value as compared with Run No. 16 using the glass for a substrate 14 in which SiO₂ content is 58% or more. The reason for this is that the SiO₂ content is decreased to the total content of Li₂O+Na₂O, and as a result, Tg is decreased and even by ion exchange, sufficient strengthening is not obtained by stress relaxation. It was found from the result that SiO₂ content in the glass for a substrate is preferably 58% in terms of mol % on the basis of oxides.

Run No. 17 using the glass for a substrate 15 in which MgO content exceeds 4% in terms of mol % on the basis of oxides had low K_{c} value as compared with Run No. 6 using the glass for a substrate 5 in which MgO content is 4% or less. The reason for this is that MgO inhibits movement of an alkali component in the glass, and as a result, ion exchange rate is decreased and sufficient strengthening is not obtained. It was found from this result that MgO content in the glass for a substrate is preferably 4% in terms of mol % on the basis of oxides.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2009-290872 filed on Dec. 22, 2009, and the contents are incorporated herein by reference.

All references cited herein are incorporated by reference herein in their entirety.

Also, all the references cited herein are incorporated as a whole.

The manufacturing method of the present invention makes it possible to obtain a glass substrate for data storage mediums, in which impact resistance is excellent, disk shape can be stabilized, and particularly generation of waviness is small, without being subjected to a specific treatment after the chemical strengthening treatment.

What is claimed is:

1. A method for manufacturing a glass substrate for data storage mediums, said method comprising a chemical strengthening treatment step of dipping a glass for a substrate in a mixed molten salt to form a compressive layer on front and back surfaces of the glass for a substrate,
wherein the glass for a substrate contains a lithium ion as an alkali component,
the mixed molten salt contains sodium nitrate, potassium nitrate and lithium nitrate, an amount of lithium nitrate being from 1 to 6% by mass, and
the glass for a substrate is dipped in the mixed molten salt at a treatment temperature of 325° C. or more and 475° C. or less for a treatment time of 30 minutes or less, under the requirement satisfying the following formula:
1900≦T×log(t²)≦2900
in which T is a treatment temperature (unit: K) and t is a treatment time (unit: second).

2. The method for manufacturing a glass substrate for data storage mediums according to claim 1, wherein the glass for a substrate subjected to said chemical strengthening treatment has a fracture toughness value K_{c} measured by an IF method according to JIS R1607, of 1.2 MPa·m^{1/2} or more.

3. The method for manufacturing a glass substrate for data storage mediums according to claim 1, wherein the mixed molten salt comprises, in terms of mass percent, from 28 to 55% of sodium nitrate and from 40 to 69% of potassium nitrate, and has a melting point of 250° C. or lower.

4. The method for manufacturing a glass substrate for data storage mediums according to claim 1, wherein, in the chemical strengthening treatment step, the step of dipping the glass for a substrate in the mixed molten salt is limited to one step.

5. The method for manufacturing a glass substrate for data storage mediums according to claim 1, wherein, in the chemical strengthening treatment step, the glass for a substrate to be dipped in the mixed molten salt has a temperature not lower than the melting point of the mixed molten salt.

6. The method for manufacturing a glass substrate for data storage mediums according to claim 1, wherein, in the chemical strengthening treatment step, after dipping the glass for a substrate in the mixed molten salt, the glass for a substrate is not annealed, and after reaching a temperature of the glass for a substrate to 300° C. or lower, the glass for a substrate is quenched by bringing into contact with a cooling medium at a cooling rate of 100° C./minute or more.

7. The method for manufacturing a glass substrate for data storage mediums according to claim 1, wherein, after the chemical strengthening treatment step, the glass for a substrate is not repolished.

8. The method for manufacturing a glass substrate for data storage mediums according to claim 1, wherein the glass for a substrate comprises, in terms of mol % on the basis of oxides, from 58 to 66% of SiO₂, from 11 to 17% of Al₂O₃, from 0 to 4% of MgO, from 8 to 16% of Li₂O, and from 2 to 9% of Na₂O, provided that Li₂O+Na₂O is from 13 to 21%.

9. The method for manufacturing a glass substrate for data storage mediums according to claim 1, wherein the glass for a substrate has a value obtained by dividing a content of Li₂O in terms of mol % on the basis of oxides by a total content (R₂O) of Li₂O, Na₂O and K₂O of 0.4 or more.

10. The method for manufacturing a glass substrate for data storage mediums according to claim 1, wherein a glass disk for storage medium molded from the glass for a substrate having been subjected to the chemical strengthening treatment has:
a flatness of 3 μm or less;
an arithmetic average waviness (Wa) with cut-off values of 0.4 mm and 5 mm on a surface between a radius of 16 mm and a radius of 28 mm from a center of a 2.5-inch disk of said glass disk, of 0.6 nm or less; and
an arithmetic average roughness (Ra) of 0.15 nm or less.

11. A glass substrate for data storage mediums, produced by the manufacturing method according to claim 1.

12. A data storage medium comprising the glass substrate for data storage mediums according to claim 11, and a magnetic recording layer formed on said glass substrate.
